(19) United States
(12) Patent Application Publication
(10) Pub. No.: US 2026/0112516 A1
(43) Pub. Date: Apr. 23, 2026

(54) NUCLEAR BATTERY AND POWER SUPPLY SYSTEM INCLUDING THE SAME

(71) Applicant: KOREA ADVANCED INSTITUTE OF SCIENCE AND TECHNOLOGY, Daejeon (KR)

(72) Inventors: Jee Hyun SEONG, Daejeon (KR); Sungbeen PARK, Daejeon (KR); Bin AHN, Daejeon (KR); Youngchul GHIM, Daejeon (KR)

(73) Assignee: KOREA ADVANCED INSTITUTE OF SCIENCE AND TECHNOLOGY, Daejeon (KR)

(21) Appl. No.: 19/323,338

(22) Filed: Sep. 9, 2025

(30) Foreign Application Priority Data
Oct. 22, 2024 (KR) 10-2024-0144753

(51) Int. Cl. G21H 1/00; H01Q 1/24

(52) U.S. Cl. CPC G21H 1/00; H01Q 1/248

(57) ABSTRACT

A nuclear battery includes a radiation source, a magnet, and an antenna. The radiation source is configured to emit electrons. The magnet has an N pole and an S pole facing each other with the radiation source disposed therebetween so as to provide a magnetic field to the radiation source. The antenna surrounds at least a portion of the radiation source in a direction perpendicular to the magnetic field and is configured to absorb electromagnetic waves generated by electrons accelerated by the magnetic field in the direction perpendicular to the magnetic field.

### CROSS-REFERENCE TO RELATED APPLICATIONS

This application claims priority to and benefits of Korean Patent Application No. 10-2024-0144753 under 35 U.S.C § 119, filed on Oct. 22, 2024, in the Korean Intellectual Property Office, the contents of which are incorporated herein in its entirety by reference.

### BACKGROUND

### 1. Technical Field

The present disclosure relates to a nuclear battery and a power supply system including the same, and more particularly, to a nuclear battery utilizing cyclotron radiation and a power supply system including the same.

### 2. Description of the Related Art

A nuclear battery is a device that converts nuclear energy into electrical energy. The nuclear battery generates electrical energy by utilizing energy produced from the beta decay of a radioactive isotope. Nuclear batteries have the advantage of providing a stable energy supply over an extended period of time. Nuclear energy has been attracting increasing attention in recent years as a result of global trends to reduce carbon emissions and restrict the use of fossil fuels.

Several methods are known for converting nuclear energy into electrical energy. For example, electrical energy can be generated by utilizing thermal energy produced during radioactive decay. The thermal energy may be converted into electrical energy through the thermoelectric effect or thermophotovoltaic energy conversion. Alternatively, electrical energy may be generated by causing electrons emitted from the radioactive decay of a radioisotope, such as in a betavoltaic cell, to collide with a semiconductor. However, these methods are limited by the inefficiencies associated with using thermal energy or by the material properties of semiconductors, resulting in poor efficiency in converting the kinetic energy of electrons into electrical energy.

### SUMMARY

The present disclosure provides a nuclear battery and a power supply system including the same, which are capable of converting nuclear energy into electrical energy with higher efficiency than conventional techniques.

The present disclosure also provides a nuclear battery and a power supply system including the same, which exhibit a long operational lifespan and high stability.

In one embodiment of the disclosure, a nuclear battery includes a radiation source, a magnet, and an antenna. The radiation source is configured to emit electrons. The magnet is arranged such that the radiation source is disposed between an N pole and an S pole facing each other, thereby providing a magnetic field to the radiation source. The antenna surrounds at least a portion of the radiation source in a direction perpendicular to the magnetic field and is configured to absorb electromagnetic waves generated by electrons accelerated in the direction perpendicular to the magnetic field.

In an example, the nuclear battery may further include a vacuum chamber configured to accommodate the radiation source in a vacuum state. The vacuum chamber may be formed of a breakable material.

In an example, the radiation source may be a Ni-63 source. The radiation source may be arranged to overlap with the central axis of the magnetic field. The radiation source may have a spherical shape.

In an example, the radiation source may include a plurality of wires extending in the direction of the magnetic field and arranged in a direction perpendicular to the magnetic field. The plurality of wires may be spaced apart from each other at intervals greater than the rotational diameter of electrons in the magnetic field.

In an example, the antenna may include a metamaterial absorber. The antenna may have a bandwidth for absorbing RF frequencies of electromagnetic waves that depend on the strength of the magnetic field, and the nuclear battery may further include a support structure for the antenna having an absorption rate for the frequencies within the bandwidth that is lower than that of the antenna.

In an example, the antenna may include a lateral antenna that surrounds the radiation source in a direction perpendicular to the magnetic field and an end antenna that surrounds the radiation source in the direction of the magnetic field. The lateral antenna may include planar patches that absorb electromagnetic waves, and the planar patches may be arranged in a columnar shape to surround the radiation source in a direction perpendicular to the magnetic field. The end antenna may include a first conical antenna positioned adjacent to the N pole and covering the radiation source in the direction of the magnetic field, and a second conical antenna positioned adjacent to the S pole and covering the radiation source in the direction of the magnetic field.

In an example, the nuclear battery may further include a trap unit disposed between the radiation source and the antenna, and the trap unit may be configured to control electrons to move within the trap unit.

In an example, the trap unit may include a magnetic mirror configured to control the distribution of the magnetic field using a plurality of coils.

In an example, the trap unit may include a lateral electrode surrounding the radiation source in a direction perpendicular to the magnetic field, a first end electrode disposed more adjacent to the N pole than the lateral electrode and having a higher voltage level than the lateral electrode, and a second end electrode disposed more adjacent to the S pole than the lateral electrode and having a higher voltage level than the lateral electrode.

In one embodiment of the disclosure, a power supply system includes a nuclear battery and an energy harvesting unit. The nuclear battery is configured to generate electromagnetic waves based on cyclotron radiation of electrons. The energy harvesting unit is configured to convert the generated electromagnetic waves into electrical energy. The nuclear battery includes a radiation source configured to emit electrons, a magnet configured to provide a magnetic field to the radiation source for generating cyclotron radiation, and an antenna configured to absorb the generated electromagnetic waves and deliver them to the energy harvesting unit.

In an example, the nuclear battery may further include a vacuum chamber configured to accommodate the radiation source in a vacuum state. The nuclear battery may also include a trap unit disposed between the radiation source and the antenna and configured to control the distribution of the magnetic field, wherein the antenna may surround the radiation source in a direction perpendicular to the magnetic field.

In an example, the energy harvesting unit may include an impedance matching circuit electrically connected to the antenna and configured to provide impedance matching between the antenna and a load, a rectifier circuit configured to convert electrical signals received through the impedance matching circuit into direct current (DC) signals, and a power management circuit configured to control the current and voltage of the DC signals.

According to one embodiment of the present disclosure, the nuclear battery and the power supply system including the same are capable of converting the energy emitted through cyclotron radiation of accelerated electrons into electrical energy, thereby achieving higher efficiency in converting the kinetic energy of electrons into electrical energy compared to conventional techniques.

Moreover, according to one embodiment of the present disclosure, the nuclear battery and the power supply system including the same may also achieve a long operational lifespan by converting the kinetic energy of electrons, generated through beta decay, into electrical energy and may provide high stability by enabling easy cessation of power generation through the use of a breakable vacuum chamber.

According to one embodiment of the present disclosure, the nuclear battery and the power supply system including the same are capable of improving the efficiency of electrical energy generation through optimization of the radiation source, optimization of the antenna, and arrangement of the trap unit.

### BRIEF DESCRIPTION OF THE DRAWINGS

These and/or other features will become apparent and more readily appreciated from the following description of the embodiments, taken in conjunction with the accompanying drawings.

FIG. 1 is a block diagram of a power supply system according to one embodiment of the present disclosure.

FIG. 2 is a diagram schematically illustrating the nuclear battery shown in FIG. 1.

FIG. 3 is a diagram for explaining cyclotron radiation in the nuclear battery shown in FIG. 2.

FIG. 4 is a perspective view schematically illustrating the antenna shown in FIG. 2.

FIG. 5 is a diagram schematically illustrating the nuclear battery shown in FIG. 1.

FIG. 6 is a diagram schematically illustrating the trap unit shown in FIG. 5.

FIG. 7 is a diagram schematically illustrating the trap unit shown in FIG. 5.

FIG. 8 is a diagram schematically illustrating the radiation source shown in FIG. 2.

FIG. 9 is a cross-sectional view schematically illustrating the plurality of wires shown in FIG. 8.

### DETAILED DESCRIPTION

Hereinafter, certain embodiments of the present disclosure will be described in more detail with reference to the accompanying drawings. In the drawings, the proportions and dimensions of components may be exaggerated for clarity and ease of explanation.

Any expressions such as “comprise” or “include” are intended to specify the presence of features, integers, steps, operations, elements, components, or combinations thereof stated in the specification, and shall not be construed to preclude any possibility of presence or addition of one or more other features, integers, steps, operations, elements, components, or combinations thereof.

Furthermore, when a component is described as being “on” another component, it may be located above or below the other component and does not necessarily imply being positioned on the upper side in the direction of gravity.

When a component is described as being “connected” or “coupled” to another component, it may be directly connected or coupled to the other component or indirectly connected or coupled via another component.

Terms such as “first” and “second” may be used when referring to components, but these terms are intended only for distinguishing one component from another and do not imply any limitation on the nature, order, or sequence of the components.

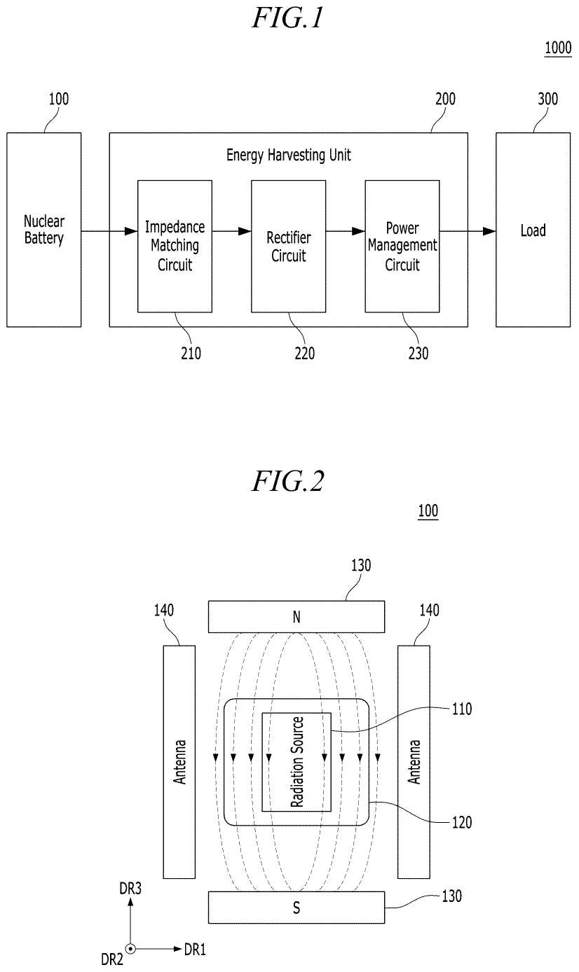

FIG. 1 is a block diagram of a power supply system according to one embodiment of the present disclosure. Referring to FIG. 1, a power supply system 1000 includes a nuclear battery 100, an energy harvesting unit 200, and a load 300.

The nuclear battery 100 is configured to convert nuclear energy into electrical energy. As used herein, “nuclear energy” refers to energy released from a change in state such as decay of an atomic nucleus of a radioactive element or a change in the mass of an atomic nucleus. In the nuclear battery 100, electrons are generated by a state change of the radioactive element, and the kinetic energy of the electrons can be converted into electrical energy.

The nuclear battery 100 may be configured to generate electromagnetic waves based on cyclotron radiation of electrons. As used herein, “cyclotron radiation” refers to the phenomenon in which a charged particle radiates electromagnetic waves when accelerated in a direction perpendicular to a magnetic field to undergo circular or spiral motion. The nuclear battery 100 may transmit electrical signals based on the radiated electromagnetic waves to the energy harvesting unit 200.

The nuclear battery 100 may include a radiation source configured for the state change of the radioactive element, a magnet configured to provide a magnetic field for generating cyclotron radiation, and an antenna configured to receive the radiated electromagnetic waves and deliver them to the energy harvesting unit 200. The detailed configuration of the nuclear battery 100 will be described later.

The energy harvesting unit 200 may be configured to convert the electromagnetic waves generated by the nuclear battery 100 into electrical energy. The energy harvesting unit 200 may collect electrical energy based on the electromagnetic waves received from the antenna of the nuclear battery 100. The energy harvesting unit 200 may process and control the electromagnetic waves generated by the nuclear battery 100 into electrical signals suitable for delivery to the load 300. To this end, the energy harvesting unit 200 may include an impedance matching circuit 210, a rectifier circuit 220, and a power management circuit 230.

The impedance matching circuit 210 is provided to match the impedance between the nuclear battery 100 and the load 300. The impedance matching circuit 210 may be electrically connected to the antenna of the nuclear battery 100 and configured to receive electrical signals based on the electromagnetic waves. The impedance matching circuit 210 may be configured to match the input impedance and output impedance to eliminate reflection losses.

The rectifier circuit 220 is configured to rectify the electrical signals received through the impedance matching circuit 210. The rectifier circuit 220 may be configured to convert alternating current (AC) electrical signals into direct current (DC) signals. To this end, the rectifier circuit 220 may include diodes and capacitors for rectification.

The power management circuit 230 is configured to control the current and voltage of the electrical signals converted through the rectifier circuit 220. The power management circuit 230 may control the current and voltage such that the power supplied to the load 300 has a maximum efficiency. Accordingly, the power supply system 1000 can efficiently manage and supply power provided to the load 300.

The load 300 may receive power from the energy harvesting unit 200 under the control of the power management circuit 230. The load 300 may include various electronic devices for using the supplied power. Alternatively, the load 300 may include a battery or storage device for storing the supplied power.

The power supply system 1000 may be understood as an exemplary system utilizing the nuclear battery 100 according to one embodiment of the present disclosure. By utilizing the characteristics of the nuclear battery 100 for generating electrical energy, which will be described later, various electronic circuits, electronic devices, and electronic systems can be operated.

FIG. 2 is a diagram schematically illustrating the nuclear battery shown in FIG. 1. Referring to FIG. 2, the nuclear battery 100 includes a radiation source 110, a vacuum chamber 120, a magnet 130, and an antenna 140. For purposes of describing the nuclear battery 100, a first direction DR1, a second direction DR2, and a third direction DR3 are defined. The first direction DR1 and the second direction DR2 may be understood as directions perpendicular to the general direction of the magnetic field. The third direction DR3 may be understood as the direction in which the N pole and S pole of the magnet 130 are arranged, corresponding to the general direction of the magnetic field.

The radiation source 110 is configured to emit electrons based on the decay of a radioactive isotope. As used herein, a “radioactive isotope” refers to an isotope in which the combination of protons and neutrons in the atomic nucleus is unstable and which emits electron particles in the process of transitioning to a stable state. To achieve stabilization, the radioactive isotope spontaneously emits particles having energy, such as alpha particles or beta particles, and such emission is defined as a decay phenomenon.

The type of the radiation source 110 is not particularly limited so long as it emits electrons based on a decay phenomenon. For example, the radiation source 110 may be a Ni-63 source. The Ni-63 source undergoes beta decay and is converted into Cu-63, which is non-radioactive, thereby providing an advantage in terms of safety for radioactive waste management. However, the radiation source 110 is not limited thereto and may alternatively be at least one of various sources such as a C-14 source or an H-3 source.

The kinetic energy of the electrons emitted from the radiation source 110 is converted into electrical energy. To minimize interference in the movement path of the emitted electrons, the radiation source 110 may be positioned at the center of the nuclear battery 100. For example, the radiation source 110 may be centrally arranged to overlap with the central axis of the magnetic field formed by the magnet 130.

Additionally, the radiation source 110 may have a shape designed to minimize interference in the movement path of the emitted electrons. For example, the radiation source 110 may have a spherical shape, which does not protrude in any one direction, thereby reducing collisions of electrons emitted in various directions. However, the shape of the radiation source 110 is not limited thereto and may be designed in consideration of various factors such as the internal shape of the nuclear battery 100 and the size of the radiation source 110 necessary to secure sufficient electron movement.

The vacuum chamber 120 is configured to accommodate the radiation source 110 in a vacuum state. The interior of the vacuum chamber 120 is evacuated and surrounds the radiation source 110. Accordingly, electrons emitted from the radiation source 110 may be prevented from colliding with gas molecules constituting air.

Unlike the illustration, the vacuum chamber 120 may not be included in the nuclear battery 100. For example, when the nuclear battery 100 is used in an environment such as outer space, a separate vacuum chamber 120 may not be provided in the nuclear battery 100. Additionally, unlike the illustration, the vacuum chamber 120 may be configured to further accommodate one or more other components, such as at least one of the magnet 130 and the antenna 140, in addition to the radiation source 110.

The vacuum chamber 120 may include a breakable material. In such cases, breaking the vacuum chamber 120 can interrupt the generation of electrical energy. If the vacuum chamber 120 were broken, electrons emitted from the radiation source 110 would collide with gas molecules, causing their kinetic energy to be dissipated. As a result, power generation of the nuclear battery 100 can be easily stopped. In the event of a malfunction or the need for emergency shutdown of the nuclear battery 100 or the power supply system 1000 shown in FIG. 1, the safety of the system may be ensured by physically breaking the vacuum chamber 120 to terminate power generation.

The magnet 130 is arranged to provide a magnetic field to the radiation source 110. The magnet 130 may be a permanent magnet including an N pole and an S pole. The N pole and the S pole may be arranged to face each other in the third direction DR3 with the radiation source 110 disposed therebetween. The magnetic field formed by the magnet 130 may provide a Lorentz force to electrons emitted from the radiation source 110. Accordingly, the emitted electrons may be accelerated in a direction perpendicular to the magnetic field.

The magnet 130 is configured to accelerate the electrons emitted from the radiation source 110 to induce cyclotron radiation. The emitted electrons are accelerated in a direction perpendicular to the magnetic field and undergo circular or spiral motion. As a result, the accelerated electrons may generate electromagnetic waves, a phenomenon defined herein as cyclotron radiation. Through cyclotron radiation, the electrons continuously lose kinetic energy and eventually come to rest. The electromagnetic waves generated during this process are used to convert the kinetic energy of the electrons into electrical energy.

The magnet 130 may be configured to form a sufficiently strong magnetic field to generate cyclotron radiation. For example, when the radiation source 110 is a Ni-63 source, the electrons may be emitted with an energy of approximately 67 keV. To cause such electrons to undergo circular motion, the magnet 130 may be configured to form a magnetic field of 1 T or greater.

The antenna 140 is configured to absorb electromagnetic waves generated by cyclotron radiation. The electromagnetic waves generated by cyclotron radiation may have a frequency ranging from several GHz to several tens of GHz. The antenna 140 may receive electromagnetic waves or RF signals having RF frequencies. The antenna 140 may transmit the received RF signals as electrical signals to the energy harvesting unit 200 shown in FIG. 1. Through this process, the nuclear battery 100 is capable of converting nuclear energy into electrical energy.

The type of the antenna 140 is not particularly limited so long as it is capable of receiving electromagnetic waves. For example, the antenna 140 may include a metamaterial perfect absorber (MPA) for absorbing electromagnetic waves with high efficiency. In an example, the antenna 140 may be configured to have a bandwidth corresponding to the frequency band of the electromagnetic waves.

$$f = \frac{eB}{2 π {m}_{e}} \qquad [ Mathematical Formula 1 ]$$

Referring to Mathematical Formula 1, f is defined as the cyclotron frequency, e is defined as the charge of a charged particle (electron), B is the intensity of the magnetic field, and mₑ is the mass of the particle. In other words, the RF frequency is determined based on the magnitude of the magnetic field and is independent of the energy of the electrons. Accordingly, the bandwidth of the antenna 140 may be designed to match the intensity of the magnetic field of the magnet 130. For example, in a magnetic field of 1 T, the antenna 140 may be arranged in a direction perpendicular to the magnetic field so as to have a bandwidth for absorbing frequencies of approximately 28 GHz. Based on such bandwidth design, the signal reception efficiency of the antenna 140 may be increased.

Moreover, configurations other than the antenna 140 (for example, components supporting the above-described various components) may be designed to avoid absorbing electromagnetic waves. For example, a support structure of the antenna 140 may include a material having low absorption for the frequency band of the electromagnetic waves. The support structure of the antenna 140 may be configured to have a lower absorption rate for the frequency band of the electromagnetic waves than the antenna 140 itself. For example, the support structure of the antenna 140 may be designed with lengths and widths that provide a high reflection coefficient for the frequency band of the electromagnetic waves.

The antenna 140 is configured to surround at least a portion of the radiation source 110 in the first direction DR1 and the second direction DR2. Preferably, the antenna 140 may be configured to surround the entirety of the radiation source 110. The antenna 140 is arranged in various regions where electromagnetic waves are emitted to absorb the electromagnetic waves. Although the electromagnetic waves may be radiated omnidirectionally, the antenna 140 may be positioned in regions where the electromagnetic waves predominantly reach, considering the direction of the magnetic field and the motion of the electrons. For example, the antenna 140 may have a shape surrounding the lateral side of the radiation source 110, i.e., a columnar shape centered along the third direction DR3. In another example, the antenna 140 may cover regions where the radiation source 110 is exposed and not covered by the magnet 130.

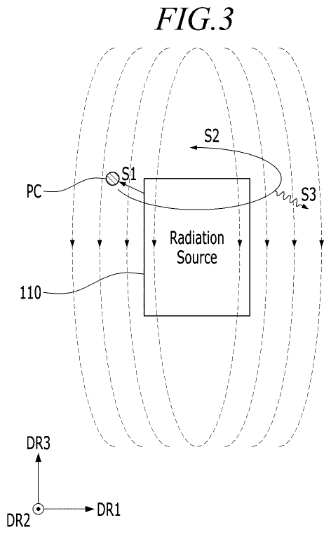

FIG. 3 is a diagram for explaining cyclotron radiation in the nuclear battery 100 shown in FIG. 2. Referring to FIG. 3, the nuclear battery 100 shown in FIG. 2 forms a magnetic field in the third direction DR3 by means of the magnet 130. The radiation source 110 is present within the formed magnetic field.

In step S1, a particle PC is emitted from the radiation source 110. For example, the radiation source 110 may emit a beta particle as a result of beta decay of a radioactive isotope. The particle PC may include electrons or positrons.

In step S2, the emitted particle PC undergoes rotational motion under the influence of the magnetic field. Assuming that the particle PC is subjected to the magnetic field in the third direction DR3, the particle PC makes circular or spiral motion about a rotational axis parallel to the third direction DR3. The particle PC is accelerated based on the Lorentz force generated by the magnetic field.

In step S3, the particle PC dissipates its kinetic energy in the form of electromagnetic waves due to the acceleration. This phenomenon is defined as cyclotron radiation. The cyclotron radiation phenomenon causes the particle PC to emit electromagnetic waves until its kinetic energy is completely exhausted. The electromagnetic waves are received by the antenna 140 of FIG. 2 and converted into electrical energy.

The generation of electrical energy through cyclotron radiation, as illustrated in FIG. 3, has higher energy conversion efficiency compared to other nuclear batteries. Since the kinetic energy of the particle PC is dissipated as electromagnetic waves, the kinetic energy of the electron can theoretically be entirely converted into electrical energy. This provides higher energy conversion efficiency than methods that convert thermal energy generated from radioactive decay back into electrical energy or that convert electrical energy by causing electrons to collide with a p-n junction semiconductor. Such high energy efficiency further enables the nuclear battery to generate more power with the same radiation source and to achieve a longer operational lifespan.

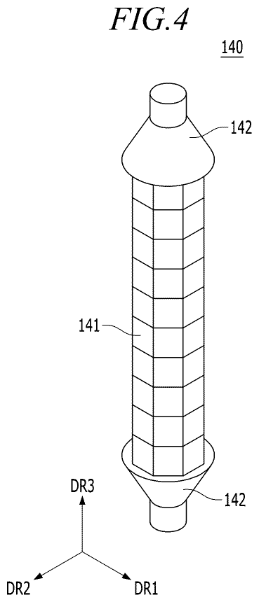

FIG. 4 is a perspective view schematically illustrating the antenna 140 shown in FIG. 2. Referring to FIG. 4, the antenna 140 includes a lateral antenna 141 and an end antenna 142. The structure of the antenna 140 in FIG. 4 is merely exemplary, and any structure capable of absorbing the above-described electromagnetic waves may be employed. For convenience of explanation, FIG. 4 will be described with reference to the same reference numerals used in FIG. 2.

The lateral antenna 141 is configured to surround the radiation source 110 in a direction perpendicular to the magnetic field. The lateral antenna 141 may have a columnar shape with a central axis parallel to the third direction DR3. The lateral antenna 141 may be configured to cover the lateral side of the radiation source 110. Accordingly, the lateral antenna 141 may absorb electromagnetic waves propagating in at least one of the first direction DR1 and the second direction DR2. The columnar shape of the lateral antenna 141 may provide structural advantages for absorbing most of the electromagnetic waves propagating in directions intersecting with the third direction DR3.

The lateral antenna 141 may include a plurality of planar patches configured to absorb electromagnetic waves. The plurality of planar patches may be arranged in a columnar shape to surround the lateral side of the radiation source 110. In the example illustrated in FIG. 4, the lateral antenna 141 is shown as having ten planar patches arranged along the third direction DR3 to form one side and eight sides in total, thereby forming an octagonal column shape. Each of the plurality of planar patches may be designed to have a bandwidth corresponding to the frequency band of the electromagnetic waves. Each of the planar patches may include electrodes electrically connected to the energy harvesting unit 200 shown in FIG. 1 and configured to deliver electrical signals based on the electromagnetic waves.

The end antenna 142 is configured to surround the radiation source 110 in the direction of the magnetic field. The end antenna 142 may have a conical shape with a central axis parallel to the third direction DR3. The end antenna 142 may be configured to cover the upper and lower portions of the radiation source 110. Accordingly, the end antenna 142 may absorb electromagnetic waves propagating in the third direction DR3. The conical shape of the end antenna 142 may provide structural advantages for efficiently absorbing axially polarized electromagnetic waves. The lateral antenna 141 and the end antenna 142 together may cover most of the propagation paths of the electromagnetic waves.

The end antenna 142 may include a conical antenna configured to cover the upper portion of the radiation source 110 (e.g., a first conical antenna) and a conical antenna configured to cover the lower portion of the radiation source 110 (e.g., a second conical antenna). The first conical antenna is positioned adjacent to the N pole of the magnet 130. The second conical antenna is positioned adjacent to the S pole of the magnet 130. Each of the first and second conical antennas are designed to have a bandwidth corresponding to the frequency band of the electromagnetic waves. Each of the first and second conical antennas may include an electrode electrically connected to the energy harvesting unit 200 shown in FIG. 1 and configured to deliver electrical signals based on the electromagnetic waves.

FIG. 5 is a diagram schematically illustrating the nuclear battery shown in FIG. 1. Referring to FIG. 5, a nuclear battery 100-1 includes a radiation source 110, a vacuum chamber 120, a magnet 130, an antenna 140, and a trap unit 150. Compared to the nuclear battery 100 shown in FIG. 2, the nuclear battery 100-1 shown in FIG. 5 further includes the trap unit 150. The radiation source 110, vacuum chamber 120, magnet 130, and antenna 140 of FIG. 5 are substantially the same as the radiation source 110, vacuum chamber 120, magnet 130, and antenna 140 of FIG. 2 and thus will not be described redundantly.

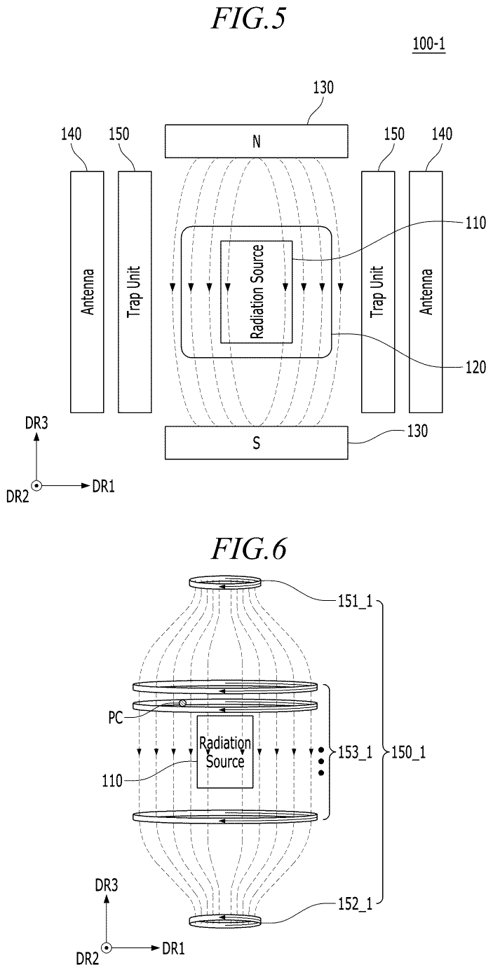

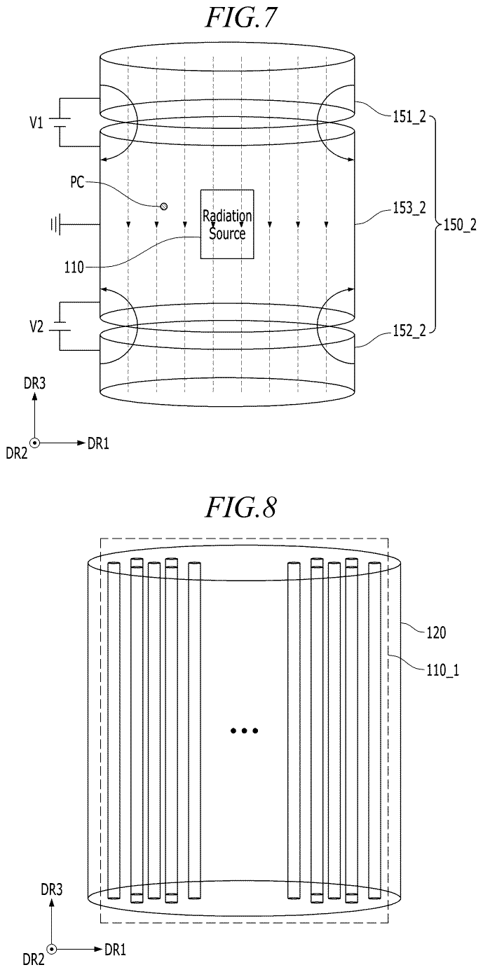

The trap unit 150 is configured to trap particles emitted from the radiation source 110. The trap unit 150 may control the movement of electrons within the trap unit 150 by adjusting the density or distribution of the magnetic field. To control the magnetic field, the trap unit 150 may include coils or electrodes. Specific examples of the trap unit 150 will be described in detail below with reference to FIGS. 6 and 7.

The trap unit 150 may trap electrons to move within a specific region. Here, the “specific region” may be defined as a region in which a magnetic field is present, the environment is under vacuum, and no other structures exist that could cause collisions. Accordingly, the electrons may avoid colliding with other structures present outside the specific region. As a result, the efficiency of converting the kinetic energy of the electrons into electrical energy may be improved.

The trap unit 150 may be disposed between the radiation source 110 and the antenna 140. The trap unit 150 may be formed to surround at least a portion of the radiation source 110. The trap unit 150 may be arranged to surround at least a portion of the vacuum chamber 120, but is not limited thereto and may alternatively be accommodated within the vacuum chamber 120. Ultimately, the trap unit 150 may be disposed at any location suitable for trapping electrons within a vacuum region, without particular limitation.

FIG. 6 is a diagram schematically illustrating the trap unit shown in FIG. 5. Referring to FIG. 6, the trap unit 150_1 includes a first end coil 151_1, a second end coil 152_1, and a lateral coil 153_1. The trap unit 150_1 corresponds to the trap unit 150 of FIG. 5 and shall be understood as an exemplary configuration for implementing a magnetic mirror. The coils illustrated in FIG. 6 are exemplary components for implementing a magnetic mirror by controlling the distribution or density of the magnetic field. However, the configuration of the trap unit 150_1 implementing the magnetic mirror is not limited to that shown in FIG. 6.

The first end coil 151_1 is configured to surround the magnetic field above the radiation source 110. The second end coil 152_1 is configured to surround the magnetic field below the radiation source 110. The first end coil 151_1 is disposed adjacent to the N pole of the magnet 130 shown in FIG. 5. The second end coil 152_1 is disposed adjacent to the S pole of the magnet 130 shown in FIG. 5. Currents may flow to form magnetic fields within the first end coil 151_1 and the second end coil 152_1.

The first end coil 151_1 and the second end coil 152_1 may form regions above and below the radiation source 110 in which the density or distribution of the magnetic field is increased. Electrons emitted from the radiation source 110 are not emitted only in directions perpendicular to the magnetic field but are emitted in various directions. The first end coil 151_1 and the second end coil 152_1 may cause electrons emitted upward or downward from the radiation source 110 to move in a reverse direction due to the increased distribution of the magnetic field. In other words, the first end coil 151_1 and the second end coil 152_1 may trap electrons within a specific region by increasing the magnetic field density.

The lateral coil 153_1 is configured to surround at least a portion of the lateral side of the radiation source 110. Currents may flow to form a magnetic field within the lateral coil 153_1. The lateral coil 153_1 may be provided as a plurality of coils, but is not limited thereto and may alternatively be provided as a single coil or, in some cases, may be omitted. The lateral coil 153_1 may expand the region for trapping electrons in the first direction DR1 and the second direction DR2. To this end, the lateral coil 153_1 may have a larger radius than the first end coil 151_1 and the second end coil 152_1. The lateral coil 153_1 may be provided to form the boundaries of the specific region.

FIG. 7 is a diagram schematically illustrating the trap unit shown in FIG. 5. Referring to FIG. 7, the trap unit 150_2 includes a first end electrode 151_2, a second end electrode 152_2, and a lateral electrode 153_2. The trap unit 150_2 corresponds to the trap unit 150 of FIG. 5 and shall be understood as an exemplary configuration for implementing a Penning trap or a Penning-Malmberg (PM) trap. The coils illustrated in FIG. 7 are exemplary configurations for implementing a Penning trap or PM trap by controlling the distribution or density of the magnetic field, but are not limited to those shown in FIG. 6.

The first end electrode 151_2 is configured to surround the magnetic field above the radiation source 110. The second end electrode 152_2 is configured to surround the magnetic field below the radiation source 110. The first end electrode 151_2 is disposed adjacent to the N pole of the magnet 130 of FIG. 5. The second end electrode 152_2 is disposed adjacent to the S pole of the magnet 130 of FIG. 5. Predetermined voltages may be applied, respectively, to the first end electrode 151_2 and the second end electrode 152_2, thereby forming an electric field in the third direction DR3 in relation to the lateral electrode 153_2.

The first end electrode 151_2 and the second end electrode 152_2 may form an electric field in the third direction DR3 above and below the radiation source 110. Electrons emitted from the radiation source 110 are not emitted only in directions perpendicular to the magnetic field but are emitted in various directions. The first end electrode 151_2 and the second end electrode 152_2 may cause electrons emitted upward or downward from the radiation source 110 to move in a reverse direction due to the increased electric field. In other words, the first end electrode 151_2 and the second end electrode 152_2 may trap electrons within a specific region by means of the electric field.

The lateral electrode 153_2 is configured to surround at least a portion of the lateral side of the radiation source 110. A magnetic field may be formed in the third direction DR3 within the first end electrode 151_2, the second end electrode 152_2, and the lateral electrode 153_2. The first end electrode 151_2 and the second end electrode 152_2 may have a higher voltage level than the lateral electrode 153_2. For example, the lateral electrode 153_2 may be grounded. Accordingly, electric fields may be formed between the first end electrode 151_2 and the lateral electrode 153_2, and between the second end electrode 152_2 and the lateral electrode 153_2.

FIG. 8 is a diagram schematically illustrating the radiation source shown in FIG. 2. Referring to FIG. 8, the radiation source 110_1 includes a plurality of wires accommodated within the vacuum chamber 120. For convenience of explanation, FIG. 8 will be described with reference to the reference numerals used in FIG. 2.

The radiation source 110_1 may be provided in the form of a plurality of metal wires. The plurality of metal wires extend in the third direction DR3, which corresponds to the direction of the magnetic field. The plurality of wires may be arranged to be spaced apart from one another in the first direction DR1 and the second direction DR2. As described above, the type of the radiation source 110_1 is not particularly limited and, for example, may be a Ni-63 source.

Each of the plurality of metal wires is configured to emit electrons, and the kinetic energy of the emitted electrons is converted into electrical energy. When there is sufficient vacuum space available for the movement of the emitted electrons, providing the radiation source 110_1 in the form of a plurality of wires may have the advantage of reducing the possibility of internal absorption of the emitted electrons. On the other hand, if the vacuum space available for electron movement were limited, providing the radiation source 110_1 as a plurality of wires might result in electrons emitted from a particular wire colliding with other wires and losing kinetic energy. In consideration of these factors, the optimal structure of the radiation source 110_1 may be designed based on the capacity, size, and intended purpose of the nuclear battery 100.

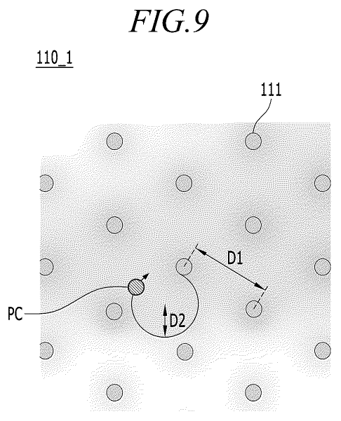

FIG. 9 is a cross-sectional view schematically illustrating the plurality of wires shown in FIG. 8. Referring to FIG. 9, the radiation source 110_1 includes a plurality of wires 111. The plurality of wires 111 correspond to the plurality of metal wires of FIG. 8. For convenience of explanation, FIG. 9 will be described with reference to the reference numerals used in FIGS. 2 and 8.

The plurality of wires 111 extend in the third direction DR3 and are spaced apart from one another in a direction perpendicular to the third direction DR3. For example, the plurality of wires 111 may be arranged such that each wire is surrounded by six adjacent wires forming a hexagonal pattern. However, the arrangement of the plurality of wires 111 is not limited thereto, and various other configurations may be employed. Each of the plurality of wires 111 may be spaced from its nearest neighbor by a first distance D1.

Each of the plurality of wires 111 may be configured to emit particles PC. The particles PC may include electrons or positrons. The emitted particles PC perform rotational motion under the influence of the magnet 130, which forms a magnetic field in the third direction DR3. The particles PC may rotate with a radius corresponding to a second distance D2. As the particles PC lose kinetic energy, the rotational radius thereof may gradually decrease.

To prevent the emitted particles PC from colliding with other wires, the wires may not be arranged in the path of motion of the particles PC. To this end, the plurality of wires 111 may be spaced apart by intervals greater than the rotational diameter of the particles PC. The first distance D1 may be greater than twice the second distance D2, which corresponds to the rotational diameter of the particles PC. For example, when the magnet 130 forms a magnetic field of 1 T, the plurality of metal wires 111 of a Ni-63 source may emit electrons having an energy of 67 keV. In such a case, the rotational diameter of the electrons may be approximately 0.4 mm, and the plurality of metal wires 111 may be spaced apart from one another by at least 0.8 mm.

While certain exemplary embodiments have been described, it shall be appreciated by those skilled in the art that various modifications and alterations are possible without departing from the technical ideas and scope of the disclosure as set forth in the claims below. The embodiments disclosed herein are not intended to limit the technical ideas of the present disclosure, and all technical concepts and ideas falling within the scope of the claims and their equivalents are to be construed as being within the scope of the present disclosure.

What is claimed is:

1. A nuclear battery comprising:
a radiation source configured to emit electrons;
a magnet having an N pole and an S pole facing each other with the radiation source disposed therebetween so as to provide a magnetic field to the radiation source; and
an antenna surrounding at least a portion of the radiation source in a direction perpendicular to the magnetic field and configured to absorb electromagnetic waves generated by electrons accelerated in the direction perpendicular by the magnetic field.

2. The nuclear battery of claim 1, further comprising a vacuum chamber configured to accommodate the radiation source in a vacuum state.

3. The nuclear battery of claim 2, wherein the vacuum chamber comprises a breakable material.

4. The nuclear battery of claim 1, wherein the radiation source is a Ni-63 source.

5. The nuclear battery of claim 1, wherein the radiation source is arranged to overlap with a central axis of the magnetic field.

6. The nuclear battery of claim 1, wherein the radiation source has a spherical shape.

7. The nuclear battery of claim 1, wherein the radiation source comprises a plurality of wires extending in a direction of the magnetic field and arranged in the direction perpendicular to the magnetic field.

8. The nuclear battery of claim 7, wherein the plurality of wires are spaced apart from one another at intervals greater than a rotational diameter of electrons in the magnetic field.

9. The nuclear battery of claim 1, wherein the antenna comprises a metamaterial absorber.

10. The nuclear battery of claim 1, wherein the antenna has a bandwidth for absorbing RF frequencies of the electromagnetic waves that depend on the intensity of the magnetic field, and
wherein the nuclear battery further comprises a support structure for the antenna having an absorption rate for the frequencies within the bandwidth that is lower than that of the antenna.

11. The nuclear battery of claim 1, wherein the antenna comprises:
a lateral antenna surrounding the radiation source in the direction perpendicular to the magnetic field; and
an end antenna surrounding the radiation source in a direction of the magnetic field.

12. The nuclear battery of claim 11, wherein the lateral antenna comprises planar patches configured to absorb the electromagnetic waves, and
wherein the planar patches are arranged in a columnar shape to surround the radiation source in the direction perpendicular to the magnetic field.

13. The nuclear battery of claim 11, wherein the end antenna comprises:
a first conical antenna positioned to be adjacent to the N pole to cover the radiation source in the direction of the magnetic field; and
a second conical antenna positioned to be adjacent to the S pole to cover the radiation source in the direction of the magnetic field.

14. The nuclear battery of claim 1, further comprising a trap unit disposed between the radiation source and the antenna,
wherein the trap unit is configured to control the electrons to move within the trap unit.

15. The nuclear battery of claim 14, wherein the trap unit comprises a magnetic mirror configured to control distribution of the magnetic field using a plurality of coils.

16. The nuclear battery of claim 14, wherein the trap unit comprises:
a lateral electrode surrounding the radiation source in the direction perpendicular to the magnetic field;
a first end electrode disposed adjacent to and closer to the N pole than the lateral electrode and being applied with a voltage having a voltage level higher than that of the lateral electrode; and
a second end electrode disposed adjacent to and closer to the S pole than the lateral electrode and being applied with a voltage having a voltage level higher than that of the lateral electrode.

17. A power supply system comprising:
a nuclear battery configured to generate electromagnetic waves based on cyclotron radiation of electrons; and
an energy harvesting unit configured to convert the generated electromagnetic waves into electrical energy,
wherein the nuclear battery comprises:
a radiation source configured to emit electrons;
a magnet configured to provide a magnetic field to the radiation source for generating the cyclotron radiation; and
an antenna configured to absorb the generated electromagnetic waves and deliver the electromagnetic waves to the energy harvesting unit.

18. The power supply system of claim 17, wherein the nuclear battery further comprises a vacuum chamber configured to accommodate the radiation source in a vacuum state.

19. The power supply system of claim 17, wherein the nuclear battery further comprises a trap unit disposed between the radiation source and the antenna and configured to control distribution of the magnetic field, and
wherein the antenna surrounds the radiation source in a direction perpendicular to the magnetic field.

20. The power supply system of claim 17, wherein the energy harvesting unit comprises:
an impedance matching circuit electrically connected to the antenna and configured to provide impedance matching between the antenna and a load;
a rectifier circuit configured to convert electrical signals received through the impedance matching circuit into direct current signals; and
a power management circuit configured to control a current and a voltage of the direct current signals.
